(19) United States
(12) Patent Application Publication
(10) Pub. No.: US 2002/0178317 A1
(43) Pub. Date: Nov. 28, 2002

(54) System and method for defining private functions of a multi-function peripheral device

(76) Inventors: Mark A. Schmisseur, Phoenix, AZ (US); Paul E. Luse, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/954,129

(22) Filed: Sep. 14, 2001

Related U.S. Application Data
(63) Continuation-in-part of application No. 09/866,005, filed on May 23, 2001.

(51) Int. Cl. G06F 13/14

(52) U.S. Cl. 710/305

(57) ABSTRACT

Disclosed are a system and method of configuring device functions of a peripheral device to communicate with multiple processing systems. A peripheral device may define a plurality of device functions accessible through a data interface with a data bus. A first processing system may be adapted to communicate with a first device function of the peripheral device through the data interface with the peripheral device. A second processing system adapted to communicate with a second device function of the peripheral device through the data interface.

This is a Continuation-in-Part of U.S. patent application Ser. No. 09/866,005 filed on May 23, 2001.

### BACKGROUND

1. Field

The subject matter disclosed herein relates to processing platforms. In particular aspects, the subject matter disclosed herein relates to processing platforms which transmit data in data busses.

2. Information

A processing platform typically comprises a host processing system coupled to one or more peripheral devices through a data bus. Such a data bus may conform to any one of several industry standard architectures such as the peripheral component interconnect (PCI) standard. A peripheral device in a processing platform may be coupled to the device and define one or more device functions which are accessible through the data bus.

A processing platform may also comprise one or more peripheral devices to perform input/output (I/O) functions for a host processing system. Such peripheral devices may comprise an I/O controller and I/O devices defining one or more I/O channels associated with I/O formats such as, for example, redundant array of independent disks (RAID), Ethernet, Fibre-Channel, SSA and IBA. To support multiple I/O channels, a single I/O device may define multiple device functions which are accessible from a data bus. There is a need to determine systems and methods for controlling access to the multiple device functions in a peripheral device from a data bus.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified.

FIG. 1 shows a schematic of a processing platform according to an embodiment of the present invention.

FIG. 2 shows a flow diagram of a process of establishing communication with two or more device functions of a peripheral device according to an embodiment of the present invention.

FIGS. 3A and 3B show a flow diagram of a process of concealing one or more device functions of a device coupled to a secondary bus according to an embodiment of the present invention shown in FIG. 1.

FIG. 4 shows a schematic of a processing platform according to an alternative embodiment of the present invention.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Machine-readable” instructions as referred to herein relates to expressions which may be understood by one or more machines for performing one or more logical operations. For example, machine-readable instructions may comprise instructions which are interpretable by a processor compiler for executing one or more operations one or more data objects. However, this is merely an example of machine-readable instructions and embodiments of the present invention are not limited in this respect.

“Storage medium” as referred to herein relates to media capable of maintaining expressions which are perceivable by one or more machines. For example, a storage medium may comprise one or more storage devices for storing machine-readable instructions. However, this is merely an example of a storage medium and embodiments of the present invention are not limited in this respect.

“Logic” as referred to herein comprises structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Also, logic may comprise processing circuitry in combination with machine-executable instructions stored in a storage medium. Additionally, logic may comprise any combination of a finite state machine circuit, processing circuitry and machine-executable instructions stored in a storage medium to perform on or more logical operations. However, these are merely examples of logic and embodiments of the present invention are not limited in this respect.

A “processing system” as discussed herein relates to a combination of hardware and software resources for accomplishing computational tasks. However, this is merely an example of a processing system and embodiments of the present invention are not limited in this respect. A “host processing system” relates to a processing system which may be adapted to communicate with a “peripheral device.” For example, a peripheral device may provide inputs to or receive outputs from an application process hosted on the host processing system. However, these are merely examples of a host processing system and peripheral device, and embodiments of the present invention are not limited in these respects.

A “data bus” as referred to herein relates to circuitry for transmitting data between devices. For example, a data bus may transmit data between a host processing system and a peripheral device. However, this is merely an example of a data bus and embodiments of the present invention are not limited in this respect. A “bus transaction” as referred to herein relates to an interaction between devices coupled in a data bus structure wherein one device transmits data addressed to the other device through the data bus structure. However, this is merely an example of a bus transaction and embodiments of the present invention are not limited in this respect.

A “bridge” as referred to herein relates to a device coupled between data busses to transmit data between devices coupled to one bus and another bus. According to an embodiment, a bridge may be coupled between two busses for transmitting data between peripheral devices and processing resources. However, embodiments of the present invention are not limited in this respect and other applications of a bridge may be used. Also, a bridge may define a “primary” data bus which couples the bridge to a host processing system and define a “secondary” data bus which is opposite the host processing system. Such a bridge as described herein may be formed according to a peripheral components interconnection (PCI) as described in the PCI-to-PCI Bridge Architecture Specification, Rev. 1.1, Dec. 18, 1998 (hereinafter “PCI-to-PCI Bridge Specification”). However, embodiments of the present invention are not limited in this respect and a bus, bridge or bus configuration according to other embodiments may be employed using other techniques.

A data bus may be coupled to one or more devices at “data interfaces” associated with addresses on the data bus. Such a data interface may comprise a physical connection to couple a device to the data bus. Also, a data interface may define a physical signaling format and an address to facilitate communication with an associated device in a bus transaction. However, these are merely examples of a data interface between a data bus and a device, and embodiments of the present invention are not limited in these respects.

A “device function” as referred to herein relates to an entity associated with a device coupled to a data bus at a data interface. The data bus may communicate with the device function through messages transmitted through the data interface. Also, multiple device functions may be associated with a single device such that a data bus may communicate with any particular device function through the transmission of signals and data through the data interface between the device and the data bus and addressed to the particular device function. However, these are merely examples of a device function and embodiments of the present invention are not limited in these respects.

“Bus enumeration” as referred to herein relates to a process including the identification of devices coupled to a data bus and allocating resources to communicate with identified devices. For example, a processing system coupled to a data bus may execute a bus enumeration process to identify devices on the data bus and any device functions provided by the identified devices, and allocate processing resources to communicate with the identified devices and device functions. Such bus enumeration process may comprise attempts to enumerate individual devices or device functions of such devices. However, this is merely an example of a bus enumeration process an embodiments of the present invention are not limited in this respect.

A “configuration transaction” as referred to herein relates to a transaction transpiring in the course of a bus enumeration process to identify a device on a data bus or a device function of such a device, and allocate resources to communicate with the identified device or device function. Such a configuration request may be initiated For devices or device functions coupled to a PCI bus as illustrated in the PCI-to-PCI Bridge Specification, for example, an enumeration process may perform Type 0 configuration transactions to identify devices and device functions coupled to a data bus and allocate resources to communicate with the identified device or device function. Also, an enumeration process may perform a Type 1 configuration transactions to identify devices and device functions coupled to a secondary data bus behind a bridge (and allocate resources to communicate with the identified device or device function) as illustrated in Chapter 3 of the PCI-to-PCI Bridge Specification. However, these are merely examples of configuration transactions and embodiments of the present invention are not limited in these respects.

A “configuration request” as referred to herein relates to an event transpiring in a configuration transaction to interrogate a device or device function of a device. For example, a configuration request may comprise a bus transaction addressed to a targeted device to interrogate the device as to the identity of the device or the identity of a device function of the targeted device. Such a configuration request may be initiated in a configuration transaction in attempt to enumerate a targeted device function. For a data bus and devices formed according to the PCI-to-PCI Bridge Specification, for example, a configuration request may comprise a bus transaction to initiate a Type 0 configuration request addressed to a device coupled to the data bus, or a bus transaction to initiate a Type 1 configuration request addressed to a device coupled to a secondary data bus (e.g., behind a bridge on the data bus). Upon receipt of a configuration request, a targeted device may provide information such as a configuration header comprising information identifying the device or device function of the device. However, these are merely examples of a configuration request and embodiments of the present invention are not limited in these respects.

A device coupled to a data bus, or one or more device functions of such a device coupled to the data bus, may be “concealed” from an enumeration procedure such that the enumeration procedure is prevented from allocating resources to communicate with the concealed device or device functions. For example, a device comprising a plurality of device functions coupled to a data bus may be adapted to provide a configuration header in response to a configuration request indicating that the device comprises a single device function, thereby concealing one or more device functions from an enumeration procedure initiating the configuration request. Also, completion of a configuration transaction targeted to a specific device function of a device may be inhibited or prevented, thereby concealing the targeted device function. However, these are merely examples of how a device or device function may be concealed in an enumeration process, and embodiments of the present invention are not limited in this respect.

An “I/O channel” as referred to herein relates to an entity through which data may be transmitted to, or received from an external system. For example, an I/O channel may comprise a peripheral device or device function to transmit data between a data bus and a communication or storage device. However, this is merely an example of an I/O channel and embodiments of the present invention are not limited in this respect.

Briefly, an embodiment of the present invention relates to a system and method of enabling communication between device functions of a peripheral device and multiple processing systems. A peripheral device may define a plurality of device functions accessible through a data interface with a data bus. A first processing system may be adapted to communicate with a first device function of the peripheral device through the data interface with the peripheral device. A second processing system may be adapted to communicate with a second device function of the peripheral device through the data interface.

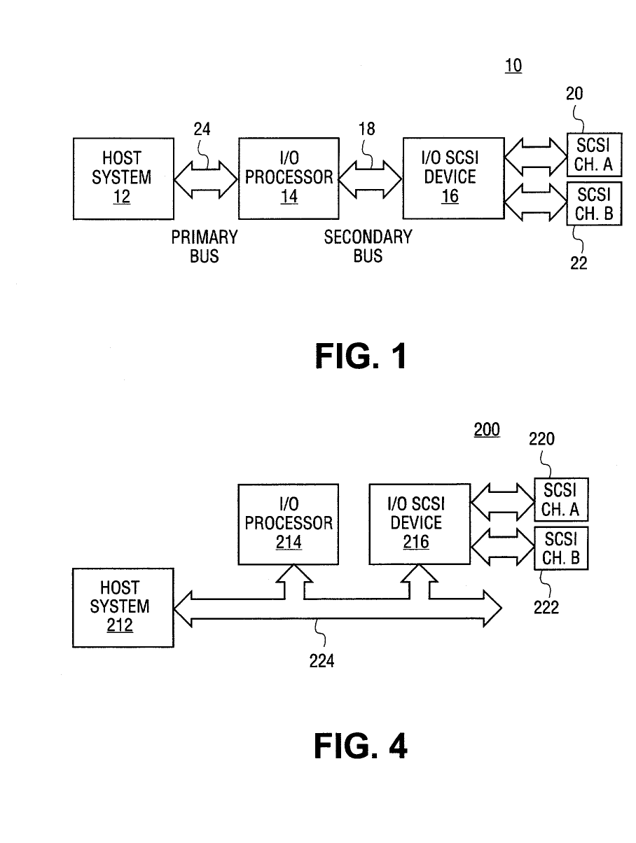

FIG. 1 shows a schematic of a processing platform 10 according to an embodiment of the present invention. An I/O processor 14 provides a first processing system for communicating with a peripheral device 16 and a host processing system 12 provides a second processing system for communicating with the peripheral device 16. The I/O processor 14 comprises an internal bridge which forms a primary bus 24 and a secondary bus 18. According to an embodiment, the primary and secondary busses 24 and 18 may be formed according to a PCI data bus structure such as that described in the PCI Local Bus Specification, Rev. 2.2, Dec. 18, 1998 published by the PCI Special Interest Group (hereinafter the “PCI Local Bus Specification”). However, this is merely an example of a bus structure which may be employed in a data bus to transmit data between devices and embodiments of the present invention are not limited in this respect. Also, the internal bridge may be formed according to the PCI-to-PCI Bridge Specification. However, this is merely an example of how a bridge may be implemented to form primary and secondary data busses in a processing platform and embodiments of the present invention are not limited in this respect.

The peripheral device 16 comprises a data interface with the secondary bus 18 to transfer data between processes at the peripheral device 16 and devices coupled to the secondary bus 18. Such a data interface may comprise any one of several data interfaces with a data bus such as, for example, a device “slot” on a PCI bus defined by a bus and device number as described in the PCI-to-PCI Bridge Specification at Chapter 13. Such a device slot may be associated with a signal definition and device pinout as described in chapter 2 and section 4.2.6 of the PCI Local Bus Specification. However, these are merely examples of how a peripheral device may comprise a data interface with a data bus and embodiments of the present invention are not limited in these respects.

In the illustrated embodiment, the peripheral device 16 may comprise an interface according to variations of the Small Computer System Interface (SCSI) established by the National Committee for Information Technology Standards (NCITS) to enable communication through first and second I/O channels 20 and 22. However, this is merely an example of how a peripheral device may facilitate communication with multiple I/O channels and other interfaces according to different formats such as, for example, Fibre-Channel, SSA, IBA or Ethernet. Each of the I/O channels 20 and 22 may be adapted to communicate with any one of several I/O devices such as, for example, a storage system such as a Redundant Array of Independent Disks (RAID), a communication port, a server, a client or other storage system directly or via a switch. The peripheral device 16 comprises at least two device functions which may be adapted to communicate through respective I/O channels 20 and 22. However, this is merely an example of how a peripheral device may implement multiple device functions to provide multiple I/O channels and embodiments of the present invention are not limited in this respect. For example, a device coupled to a slot on a PCI data bus may comprise up to eight device functions (device functions 0 through 7) such that read or write bus transactions may be individually addressed to device functions through the single slot on the PCI data bus. Again, these are merely examples of how a peripheral device may implement multiple device functions to provide multiple I/O channels and embodiments of the present invention are not limited in this respect.

According to an embodiment, the I/O processor 14 and host processing system 12 may each execute an enumeration procedure to configure resources to communicate with one or more of the devices functions associated with the I/O channels 20 and 22. The I/O processor 14 may execute a first enumeration procedure to configure resources to communicate with a first device function and initiate a subsequent bus transaction to conceal one or more device functions from the host processing system 12. The host processing system 12 may then execute a subsequent enumeration procedure to configure resources to communicate with the second device function while not detecting the existence of the concealed device function(s).

According to an embodiment, the host processing system 12 and I/O processor 14 each comprise logic to execute a bus enumeration procedure to allocate resources to facilitate communication with one or more devices coupled to the bus 24 or 18. For example, the host processing system 12 or I/O processor may comprise a processing system to initiate an enumeration procedure for configuring resources (e.g., allocation of local memory to data buffers for data transmitted between processes hosted on a processing system and a device or device function) by executing machine-readable instructions as a data bus driver stored in a storage medium. However, this is merely an example of how logic at the host processing system 12 or I/O processor 14 may execute an enumeration procedure and embodiments of the present invention are not limited in this respect.

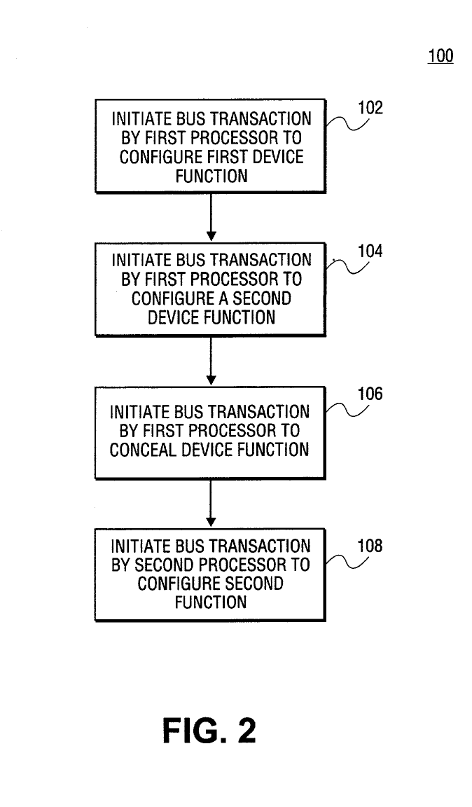

FIG. 2 shows a flow diagram of a process of enumerating two device functions of the peripheral device 16 according to an embodiment of the present invention. The I/O processor 14 may initiate a first bus transaction on the secondary bus 18 to configure resources to communicate with the first device function of the peripheral device 16 at block 102 and initiate a second bus transaction on the bus 18 to configure resources to communicate with the second device function. In an embodiment in which the secondary bus 18 comprises a PCI bus, blocks 102 and 104 may comprise initiating Type 0 configuration transactions to configure resources at the I/O processor 14 to communicate with the first and second device functions as described in section 3.2.2.3.1 of the PCI Local Bus Specification. In an embodiment in which the primary bus 24 comprises a PCI bus, block 108 may comprise initiating a Type 1 configuration transaction on the primary bus 24 from the host processing system 12 (which may result in a Type 0 configuration transaction on the secondary bus 18) to configure resources at the host processing system 12 to communicate with one of the device functions associated with the peripheral device 16. However, this is merely an example of how a processing system may initiate a bus transaction to configure resources to communicate with a device function and embodiments of the present invention are not limited in this respect.

In the illustrated embodiment, the I/O processor 14 initiates a subsequent bus transaction at block 106 to conceal the first device function from the host processing system 12 when the host processing system 12 initiates a bus transaction to configure resources to communicate with the peripheral device 16 at block 108. Thus, the host processing system 12 may only configure resources to communicate with the unconcealed device function(s). In the illustrated embodiment, the I/O processor 14 initiates bus transactions to configure resources to communicate with both device functions. In alternative embodiments, the I/O processor 14 may only configure resources to communicate with the device function that is concealed from the host processing system 12 at block 106 (e.g., omitting the bus transaction at block 104) such that the I/O processor 14 and host processor 12 each exclusively communicate with one of the device functions of the peripheral device 16. However, these are merely examples of how device functions may be allocated to multiple processing system coupled to a data bus and embodiments of the present invention are not limited in these respects.

In an embodiment in which the secondary bus 18 comprises a PCI bus, a Type 0 configuration transaction may obtain information identifying the peripheral device 16 as a multi-function device from a “Header Type” field (e.g., bit 7 in this field as illustrated in Chapter 6 of the PCI Local Bus Specification). Other information in the configuration header (e.g., the Device ID register) may indicate to the enumeration process at the I/O processor 14 that one of the device functions is to be concealed. The bus transaction at block 106 may initiate clearing a bit in the Header Type field of the configuration header at the peripheral device 16 to indicate to the host processing system 12 that the peripheral device 16 has a single device function. At block 108 the host processing system 12 may attempt to configure resources with a first device function associated with the I/O channel as a second device function is being concealed by the modification of the configuration header of the peripheral device 16. With the Header Type field signifying single function device, the host processing terminates the enumeration process for the device after configuring the first function. Nevertheless, this is merely an example of how a processing system may initiate a bus transaction with a peripheral device to conceal a device function of the peripheral device, and embodiments of the present invention are not limited in this respect.

According to an embodiment, the I/O processor 14 may maintain a configuration header in a memory comprising one or more write modifiable portions to enable the I/O processor 14 to modify the configuration header to conceal the second function from the host processing system 12. In an embodiment in which the secondary bus 18 is a PCI bus, a bus transaction may set or clear bits indirectly through an extended header register in the configuration header of the peripheral device 16 which is readable and write modifiable from the secondary bus 18. However, this is merely an example of how registers in a configuration header may be write modifiable and embodiments of the present invention are not limited in these respects.

According to an embodiment, the host processing system 12 may host a device driver to communicate with the peripheral device 16 following an enumeration process. Such a device driver may be configured to communicate with one or more of the device functions of the peripheral device 16 in response to the enumeration process. In some embodiments, the device driver may be configured to communicate with unconcealed device functions even though the device driver is prevented from communicating with the concealed device functions. Here, the host processing system 12 may determine how to configure the device driver based upon modified information in the configuration header data of the peripheral device 16 which may be accessed during an enumeration process. Such modified configuration header data may be a duplication of the aforementioned modified Header Type data in a read-writable Device ID register in an embodiment in which the secondary bus 18 comprises a PCI bus. In an alternative embodiment in which the secondary bus 18 comprises a PCI bus, the I/O processor 14 may modify information in a read-writable extended header register in the configuration header data (e.g., a Device ID register of a configuration header of a PCI device) of the peripheral device 16. The host processing system 12 may then configure the driver to communicate to the unconcealed device function.

According to an embodiment, a bridge formed in the I/O processor 14 between the primary bus 24 and secondary bus 18 comprises logic that ensures the I/O processor 14 executes an enumeration procedure to configure resources for devices on the secondary bus 18 prior to completion of an enumeration process at block 108. For example, the bridge may suspend completion of an enumeration procedure to configure processing resources at the host processing system 12 to communicate with devices coupled to the secondary bus 18 until completion of enumeration processes to configure resources at the I/O processor 14 to communicate with devices coupled to the secondary bus 18. In an embodiment in which the primary bus 24 comprises a PCI bus, for example, the bridge may retry Type 1 configuration transactions on the primary bus 24 until the I/O processor 14 completes enumeration of devices on the secondary bus 18. However, this is merely an example of how logic at a bridge may ensure that enumeration of devices and device functions on a secondary bus is completed by a first processing system before completion of enumeration of the devices by a second processing system, and embodiments of the present invention are not limited in these respects.

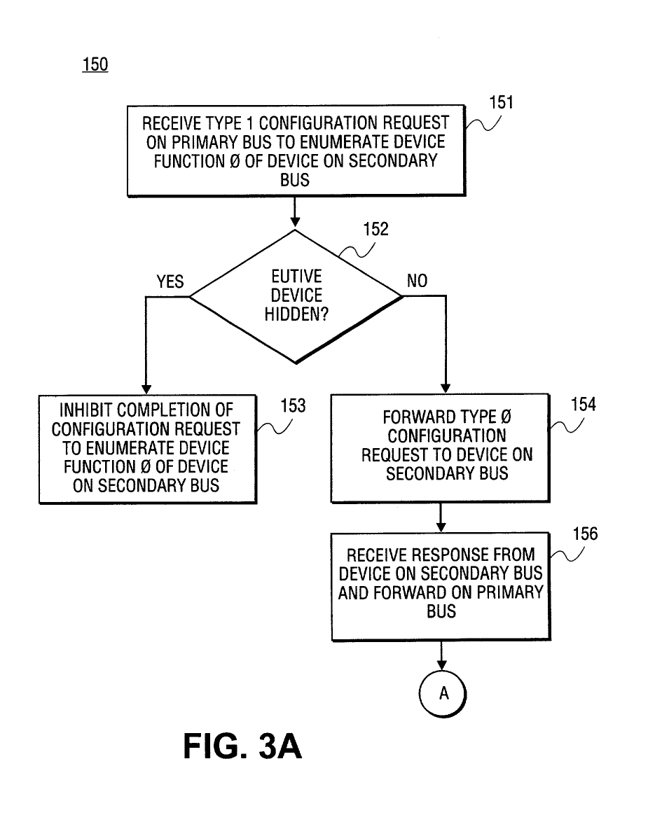

FIGS. 3A and 3B show a flow diagram illustrating a process 150 performed in connection with a bridge according to an alternative embodiment of the present invention illustrated in FIG. 1. In the presently illustrated embodiment, the I/O processor 14 may comprise logic to selectively conceal one or more device functions of the peripheral device 16. The data busses 18 and 24 may comprise data busses formed according to the PCI Local Bus Specification, and the I/O processor 14 comprises a bridge (not shown) which is formed according to the PCI-to-PCI Bridge Specification. The bridge may orient the data bus 24 as a primary bus and the data bus 18 as a secondary data bus. However, this is merely an example of how a bridge may be formed to couple a primary data bus to a secondary data bus and embodiments of the present invention are not limited in this respect.

According to an embodiment, the bridge may provide address and data (AD) pins to the devices on the secondary data bus 18 as described in section 2.2.2 of the PCI Local Bus Specification, and may control an initialization device select (IDSEL) signal to each device on the secondary data bus 18 as described in section 2.2.3 of the PCI Local Bus Specification. Accordingly, the peripheral device 16 may decode a configuration command forwarded from the bridge when 1) its IDSEL signal is asserted and 2) AD[10:08] match a device function that is implemented by the peripheral device 16. Upon decoding the configuration command, the peripheral device 16 may assert a device select (DVSEL#) signal to claim the transaction as described in section 3.2.2.3.4 of the PCI Local Bus Specification. If the peripheral device does not respond (e.g., if the function addressed in AD[10:08] does not match a device function implemented in the peripheral device 16), an absence of the DVSEL# may result in a Master-Abort termination condition as described in section 3.3.3.1 of the PCI Local Bus Specification. This Master-Abort termination condition may then be detected at an upstream device controlling the enumeration process (e.g., an upstream device initiating a Type 1 configuration transaction on the primary data bus 24 directed to the unimplemented device function).

According to an embodiment, logic at the I/O processor 14 may inhibit completion of a Type 1 configuration transaction to enumerate a device (or device function of the device) by causing the AD pin tied to the IDSEL of the corresponding device to be masked during configuration command cylces. This may prevent assertion of the IDSEL input of the corresponding device during the configuration command cycle. A Master-Abort termination condition may then result such that the configuration transaction (to enumerate the corresponding device or device function of the device) is not completed. However, this is merely an example of inhibiting completion of a configuration transaction directed to a device (or device function of a device) and embodiments of the present invention are not limited in this respect.

In the illustrated embodiment, the I/O processor 14 comprises logic to determine which devices (or device functions of devices) on the secondary data bus 18 are to be concealed from an enumeration process. For example, the I/O processor 14 may maintain a secondary ID select register (SISR) comprising an array of bits where each bit may correspond with a device on the secondary data bus 18. A process hosted on the I/O processor 14 may set a bit in the SISR to indicate that the corresponding device is to be affected.

The I/O processor 14 may then maintain a secondary function select register (SFSR) comprising an array of bits where each bit is associated with a device to indicate whether an affected device (as indicated by a corresponding bit in the SISR) is to be completely concealed or whether any device functions other than device function 0 are to be concealed. For example, setting bit in the SISR corresponding with a device in combination with unsetting a corresponding bit in the SFSR may indicate that the entire device is to be concealed. Setting the bit in the SISR in combination with setting the bit in the SFSR may then indicate that device function 0 is not to be concealed, but that additional device functions (e.g., device functions 1 through 7) are to be concealed. Accordingly, function 0 would be accessible by upstream devices coupled to the primary data bus 24 while other device functions may be concealed from such upstream devices. However, this is merely an example of how logic may indicate whether an entire device or one or more device functions are to be concealed from an enumeration process, and embodiments of the present invention are not limited in this respect.

In alternative embodiment, each bit in the SFSR may correspond with a device function in each of a plurality of devices coupled to the secondary data bus 18. Setting a bit in the SFSR may indicate that that the corresponding device function in each of the affected devices (as indicated by a bit set in the SISR) is to be concealed from the enumeration process. Upstream devices coupled to the primary data bus 24 may then enumerate device functions of the affected devices corresponding with the unset bits in the SFSR (indicating that these device functions are not concealed). However, this is merely an example of how a logic may indicate that selected device functions in a plurality of devices are to be concealed from an enumeration process and embodiments of the present invention are not limited in this respect.

In an alternative to defining hidden or concealed device functions by setting bits in the SISR and SFSR as illustrated above, the I/O processor 14 may maintain a secondary private device register (SPDR) for each device on the secondary bus where each bit set corresponds to a device function of the device to be hidden or concealed from upstream devices. Setting all of the bits in a SPDR may indicate that the entire device (e.g., all device functions of the device) is to be concealed. Alternatively, setting a single bit to conceal an initial device function (e.g., device function 0 of the device) may also have effect of concealing the entire device if enumeration of additional device functions (e.g., device functions 1 through 7) depends on a successful enumeration of the initial device function.

The process 150 illustrates logic at the I/O processor 14 to respond to Type 1 configuration transactions on the primary data bus 24 directed to a device on the secondary data bus 18. In particular, diamond 152 through block 166 illustrate logic at the I/O processor 14 to conceal the device, or selectively conceal one or more device functions of the device (e.g., one or more of device functions 1 through 7), from an enumeration process initiating the Type 1 configuration requests at the primary data bus 24. Such logic may comprise, for example, machine-readable instructions stored in a memory of the I/O processor 14 to be executed by a processing circuit in the I/O processor 14 to control the forwarding of Type 0 configuration requests to the secondary bus 18 in response to Type 1 configuration requests received on the primary data bus 24, and/or control the forwarding of responses from devices on the secondary data bus 18 to the (forwarded) Type 0 configuration requests to the primary data bus 24. Alternatively, such logic may be implemented as a finite state machine in an application specific integrated circuit (ASIC) or a field programmable gate array (FPGA) circuit. However, these are merely examples of how logic may be implemented in association with a bridge to control the forwarding of configuration requests from a primary bus to a secondary bus, or the forwarding of responses to configuration requests from a secondary bus to a primary bus, and embodiments of the present invention are not limited in these respects.

At block 151, the bridge receives a Type 1 configuration request on the primary data bus 24 to enumerate a device function (e.g., device function 0) of the peripheral device 16 coupled to the secondary data bus 18. Diamond 152 determines whether a device (and all of its device functions) of the peripheral device 14 as addressed in a Type 1 configuration request is to be concealed from the enumeration process. For example, logic corresponding with the diamond 152 may determine that an entire device is to be concealed based upon a corresponding bit in a SISR and/or SFSR as discussed above. Alternatively, logic corresponding with the diamond 152 may determine whether an entire device is to be concealed based upon whether one or all bits of a corresponding SPDR are set. However, these are merely examples of how logic may determine whether an entire device is to be concealed from an enumeration process and embodiments of the present invention are not limited in this respect.

If the entire device is not to be concealed, diamond 152 permits the completion of the configuration transaction to enumerate the device function 0 by permitting the Type 1 configuration transaction to be forwarded to the secondary data bus 18 as a Type 0 configuration transaction at block 154, and forwarding a response from the additional device function back to the primary data bus 24 at block 156. The bridge may then receive subsequent Type 1 configuration requests to enumerate additional device functions (e.g., device functions 1 through 7) of the peripheral device 16. Otherwise, if diamond 152 determines that the entire device is to be concealed, block 153 may inhibit completion of the Type 1 configuration request by masking the AD line associated with the IDSEL signal to the device as discussed above.

Block 158 through block 166 illustrates logic at the I/O processor 14 to selectively conceal one or more additional device functions of a device from an enumeration process initiating the Type 1 configuration requests. The bridge may receive configuration requests to enumerate additional device functions at block 158. Diamond 160 determines which of the additional device functions of the peripheral device 14 as addressed in a Type 1 configuration request are to be concealed from the enumeration process. For example, logic at diamond 160 may determine that the additional device function is to be concealed if a corresponding bit in an SISR (corresponding with the device) is set and a corresponding bit in an SFSR (corresponding with the additional device function) is set as discussed above. Alternatively, logic at diamond 160 may determine that the additional device function is to be concealed if corresponding bits in an SISR and SFSR indicate that only the initial device function (device function 0) is to be enumerated (and all additional device functions are to be concealed). Also, logic at diamond 160 may determine that the additional device function is to be concealed if a bit (corresponding with the additional device function) in an SPDR associated with the device is set. However, these are merely examples of how logic may determine whether an additional device function is to be concealed and embodiments of the present invention are not limited in these respects.

If the additional device function is not to be concealed, block 162 may permit completion of the configuration transaction to enumerate the additional device function by permitting the Type 1 configuration transaction to be forwarded to the secondary data bus 18 as a Type 0 configuration transaction, and forwarding a response from the additional device function back to the primary data bus 24. Otherwise, if diamond 160 determines that the additional device function is to be concealed, block 164 may inhibit completion of the Type 1 configuration request by masking the AD line associated with the IDSEL signal to the device as discussed above.

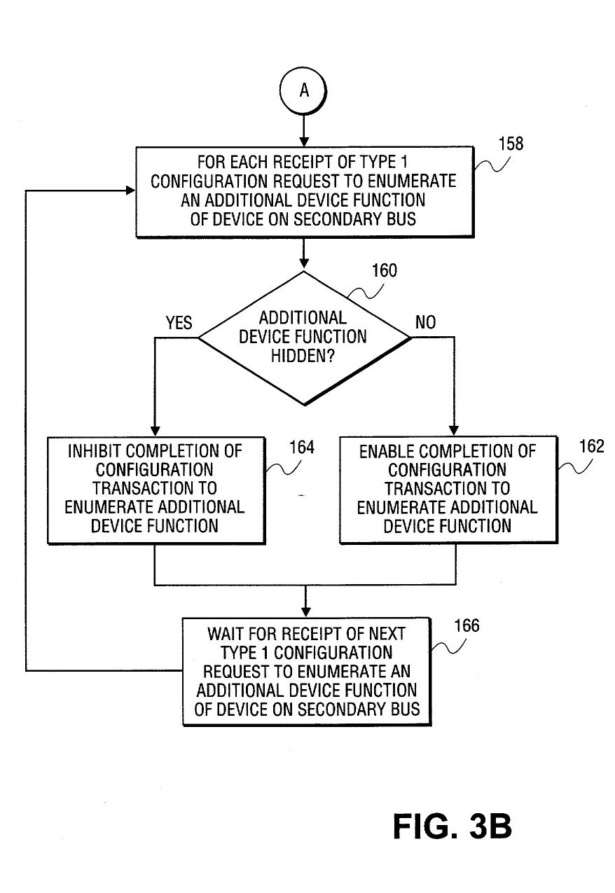

FIG. 4 shows a schematic diagram of a processing platform 200 comprising a peripheral device 216 according to an alternative embodiment of the present invention. The peripheral device 216 comprises two or more device functions where at least two device functions correspond with the I/O channels 220 and 222. A data bus 224 is coupled to directly to an I/O processor 214, a peripheral device 216 and a host processing system 212 such that the host processing system 212 may enumerate device functions of the peripheral device 216 independently of any bridge coupled between the bus 224 and the peripheral device 216. As in the embodiments discussed above with reference to FIGS. 1 and 2, the I/O processor 214 may comprise logic to conceal one or more of the device functions of the peripheral device 216 by, for example, modifying read-writable registers in configuration header data at the peripheral device 216 as part of a enumeration procedure (e.g., as discussed above with reference to blocks 102, 104 and 106 in FIG. 2). Logic at the host processing system 212 may then configure resources to communicate with the unconcealed device function(s) (e.g., as discussed above with reference to block 108 in FIG. 2).

In the illustrated embodiment, the I/O processor 214 may temporarily inhibit the host processing system 212 from enumerating one or more devices on the data bus 224. The host processing system 212 may enumerate the I/O processor 214 prior to enumerating the peripheral device 216 allowing the I/O processor 214 to enumerate the peripheral device 216. This would enable the I/O processor 214 to initiate one or more bus transactions to enumerate one or more device functions of the peripheral device 216 and to conceal one or more device functions from a subsequent enumeration process initiated at the host processing system 212. In an embodiment in which the data bus 224 comprises a PCI bus, for example, the I/O processor 214 may comprise logic to control the “IDSEL” signal (see, e.g., Sections 3.2.2.3.4 and 3.2.2.3.5 of the PCI Local Bus Specification) on a data interface coupling the data bus 224 and the peripheral device 216. Such logic to control the IDSEL signal may be implemented in, for example, the I/O processor 214 or discrete logic as described in U.S. patent application Ser. No 09/472,502 filed on Dec. 27, 1999, assigned to Intel Corporation and incorporated herein by reference. For example, the I/O processor 214 may comprise logic to assert an optional PCI signal “TMS” to inhibit the IDSEL signal on the data interface to the peripheral device 216. However, this is merely an example of how a first processing system may temporarily inhibit a second processing system from enumerating a peripheral device on a data bus, and embodiments of the present invention are not limited in this respect.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. An apparatus comprising:
a first interface to a primary bus;
a second interface to a secondary bus; and
logic to conceal from a processing system coupled to the primary bus one or more device functions of a device coupled to the secondary bus.

2. The apparatus of claim 1, wherein the apparatus further comprises:
logic to receive configuration requests from the primary bus to enumerate one or more device functions of the device coupled to the secondary bus, each configuration request being initiated in a configuration transaction; and
logic to selectively inhibit completion of one or more configuration transactions initiating a configuration request.

3. The apparatus of claim 1, wherein the apparatus further comprises:
logic to receive a configuration request on the primary bus to enumerate a first device function of the device coupled to the secondary data bus;
logic to receive on the primary data bus one or more subsequent configuration requests to enumerate one or more additional device functions of the device coupled to the second data bus; and
logic to selectively inhibit completion of one or more configuration transactions associated with the subsequent configuration requests.

4. The apparatus of claim 1, wherein the apparatus further comprises logic to conceal from the processing system one or more selected device functions of each of a plurality of selected devices coupled to the secondary bus.

5. The apparatus of claim 4, wherein the apparatus further comprises:
logic to maintain a first register indicating the selected devices;
logic to maintain a second register indicating the one or more selected device functions of each of the selected devices to be concealed from the processing system; and
logic to inhibit forwarding to each device indicated in the first register configuration requests to enumerate the one or more device functions indicated in the second register.

6. The apparatus of claim 1, wherein the apparatus further comprises logic to conceal from the processing system one or more device functions of one or more devices coupled to the secondary bus.

7. The apparatus of claim 6, wherein the apparatus further comprises:
logic to maintain a register for each device coupled to the secondary bus indicating one or more selected device functions of the device to be concealed from the processing system; and
logic to inhibit forwarding configuration requests to or each device coupled to the secondary bus to enumerate the one or more device functions indicated in the register of the device.

8. The apparatus of claim 1, wherein the apparatus further comprises logic to mask an AD signal associated with an IDSEL input of the device coupled to the secondary data bus in response to configuration requests to enumerate a device function to be concealed from the processing system.

9. A system comprising:
a processing system;
a peripheral device coupled to the processing system through a primary bus and coupled to a secondary bus; and
a device coupled to the peripheral device through the secondary bus,
wherein the peripheral device further comprises logic to conceal from the processing system one or more device functions of the device coupled to the secondary bus.

10. The system of claim 9, wherein the peripheral device comprises a bridge coupled between the primary bus and the secondary bus.

11. The system of claim 9, wherein the peripheral device further comprises:
logic to receive configuration requests from the primary bus to enumerate one or more device functions of the device coupled to the secondary bus, each configuration request being initiated in a configuration transaction; and
logic to selectively inhibit completion of one or more configuration transactions initiating a configuration request.

12. The system of claim 9, wherein the peripheral device further comprises:
logic to receive a configuration request on the primary bus to enumerate a first device function of the device coupled to the secondary data bus;
logic to receive on the primary data bus one or more subsequent configuration requests to enumerate one or more additional device functions of the device coupled to the second data bus; and
logic to selectively inhibit completion of one or more configuration transactions associated with the subsequent configuration requests.

13. The system of claim 9, wherein the peripheral device further comprises logic to conceal from the processing system one or more selected device functions of each of a plurality of selected devices coupled to the secondary bus.

14. The system of claim 14, wherein the peripheral device further comprises:
logic to maintain a first register indicating the selected devices;
logic to maintain a second register indicating the one or more selected device functions of each of the selected devices to be concealed from the processing system; and
logic to inhibit forwarding to each device indicated in the first register configuration requests to enumerate the one or more device functions indicated in the second register.

15. The system of claim 9, wherein the peripheral device further comprises logic to conceal from the processing system one or more device functions of one or more devices coupled to the secondary bus.

16. The system of claim 15, wherein the peripheral device further comprises:
logic to maintain a register for each device coupled to the secondary bus indicating one or more selected device functions of the device to be concealed from the processing system; and
logic to inhibit forwarding configuration requests to or each device coupled to the secondary bus to enumerate the one or more device functions indicated in the register of the device.

17. The system of claim 9, wherein the peripheral device further comprises logic to mask an AD signal associated with an IDSEL input of the device coupled to the secondary data bus in response to configuration requests to enumerate a device function to be concealed from the processing system.

18. A method comprising:
receiving at an interface with a first data bus one or more configuration requests to enumerate one or more device functions of a device coupled to a second data bus, each configuration request being initiated by a configuration transaction; and
selectively inhibiting completion of configuration transactions initiating one or more of the configuration requests.

19. The method of claim 18, the method further comprising:
receiving a configuration request on the first data bus to enumerate a first device function of the device coupled to the second data bus;
receiving on the primary data bus one or more subsequent configuration requests to enumerate one or more additional device functions of the device coupled to the second data bus; and
selectively inhibiting completion of one or more configuration transactions associated with the subsequent configuration requests.

20. The method of claim 18, wherein the method further comprises:
maintaining a first register indicating selected devices coupled to the second data bus;
maintaining a second register indicating one or more selected device functions of each of the selected devices to be concealed from a processing system coupled to the first data bus; and
inhibiting forwarding to each device indicated in the first register configuration requests to enumerate the one or more device functions indicated in the second register.

21. The method of claim 18, wherein the method further comprises:
maintaining a register for each of a plurality of devices coupled to the second data bus, the register indicating one or more selected device functions of the device to be concealed from a processing system coupled to the first data bus; and
inhibiting forwarding configuration requests to or each device coupled to the second bus to enumerate the one or more device functions indicated in the register of the device.

22. The method of claim 18, wherein the method further comprises masking an AD signal associated with an IDSEL input of the device coupled to the second data bus in response to configuration requests to enumerate a device function of the device.

23. An article comprising:
a storage medium comprising machine-readable instructions stored thereon for:
receiving at an interface with a first data bus one or more configuration requests to enumerate one or more device functions of a device coupled to a second data bus, each configuration request being initiated by a configuration transaction; and
selectively inhibiting completion of configuration transactions initiating one or more of the configuration requests.

24. The article of claim 23, wherein the storage medium further comprises machine-readable instructions stored thereon for:
receiving a configuration request on the primary bus to enumerate a first device function of the device coupled to the secondary data bus;
receiving on the primary data bus one or more subsequent configuration requests to enumerate one or more additional device functions of the device coupled to the second data bus; and
selectively inhibiting completion of one or more configuration transactions associated with the subsequent configuration requests.

25. The article of claim 23, wherein the storage medium further comprises machine-readable instructions stored thereon for:
maintaining a first register indicating selected devices coupled to the second data bus;
maintaining a second register indicating one or more selected device functions of each of the selected devices to be concealed from a processing system coupled to the first data bus; and
inhibiting forwarding to each device indicated in the first register configuration requests to enumerate the one or more device functions indicated in the second register.

26. The article of claim 23, wherein the storage medium further comprises machine-readable instructions stored thereon for:
maintaining a register for each of a plurality of devices coupled to the second data bus, the register indicating one or more selected device functions of the device to be concealed from a processing system coupled to the first data bus; and
inhibiting forwarding configuration requests to or each device coupled to the second bus to enumerate the one or more device functions indicated in the register of the device.

27. The article of claim 23, wherein the storage medium further comprises machine-readable instructions stored thereon for masking an AD signal associated with an IDSEL input of the device coupled to the second data bus in response to configuration requests to enumerate a device function of the device.

28. A device comprising:
a data interface adapted to be coupled to a data bus;
logic to define a plurality of device functions addressable at the data interface;
logic to provide a configuration header at the data interface in response to configuration requests received at the data interface; and
logic to conceal one or more device functions in response to a bus transaction.

29. The device of claim 28, wherein the device further comprises:
a memory to store one or more data fields of a configuration header; and
logic to change one or more data fields in the memory in response to a first bus transaction to conceal one or more of the device functions from subsequent bus transactions.
